(19) United States
(12) Patent Application Publication
(10) Pub. No.: US 2006/0150166 A1
(43) Pub. Date: Jul. 6, 2006

(54) Method of producing a document based on a scheme that generically describes the format of a bit stream

(76) Inventors: Sylvain Devillers, Bruxelles (FR); Myriam Amielh-Caprioglio, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/545,644

(22) PCT Filed: Feb. 3, 2004
(86) PCT No.: PCT/IB04/00324

§ 371 Date: Aug. 16, 2005

(30) Foreign Application Priority Data
Feb. 19, 2003 (EP) 03290407.0

(51) Int. Cl. G06F 9/45

(52) U.S. Cl. 717/141

(57) ABSTRACT

The invention proposes a method of issuing a bit stream organized in fields according to a certain bit stream format. Each field of the bit stream has a value and semantics. According to the invention the field semantics is issued with the value of the field when the bit stream is displayed so as to provide a version of the bit stream that is human-readable. According to the invention, a schema is proposed that, in addition to generically describing the bit stream format, also comprises components containing said field semantics. This schema is used by a parser for syntactically analyzing an input bit stream to be displayed, thereby generating a structured description of said bit stream. A transformation is then applied to the structured description to generate a document formatted for display.

### FIELD OF THE INVENTION

The invention relates to a method of issuing a bit stream organized in fields according to a certain format. The invention also relates to with a schema that generically describes such a bit stream format, and is to be used for implementing said method of issuing a bit stream. The invention also relates to a computer program that comprises instructions for implementing said method of issuing a bit stream. The invention further relates to a software comprising such a schema and such a computer program, and to a storage media for storing such software.

Bit streams usually have a compact binary aspect that is not human readable. The invention proposes a method for issuing a bit stream in a human-readable form. The invention is advantageously used for debugging software designed for reading/writing bit streams. For instance, it is advantageously used for validating software designed for encoding/decoding a bit stream (such software is generally called “codec”).

### BACKGROUND OF THE INVENTION

International patent application WO02/069187 filed by Koninklijke Philips Electronics N.V. and published on Sep. 06, 2002 discloses a schema that generically describes a bit stream format, and a method of syntactically analyzing a bit stream that is compliant with said format, by using said schema, so as to generate a structured description of the bit stream, said structured description being an instance of said schema. The application that is contemplated in this prior art is the adaptation of content.

The present invention is directed to another application of such a method of syntactically analyzing a bit stream.

### SUMMARY OF THE INVENTION

The application that is contemplated in the present invention is issuing bit streams that are organized in fields according to a certain format, said fields having a value and semantics called field semantics.

A method of issuing a bit stream according to the invention is defined in claims 1 to 6 of the present patent application. A schema according to the invention is defined in claims 7 and 8. A computer program according to the invention is defined in claim 9, software according to the invention is defined in claim 10, and a storage medium according to the invention is defined in claim 11.

In the present invention, an enhanced schema is proposed. In addition to generically describing the bit stream format, the proposed enhanced schema includes components containing the field semantics of at least part of the fields defined in the bit stream format.

These components are used during the syntactical analysis of the bit stream so as to generate a structured description of the bit stream that comprises not only the value of the fields but also the field semantics.

Then a transformation is applied to the structured description for producing a document comprising at least the field semantics and an indication of the value of the field, for at least part of the fields of the bit stream. The function of this transformation is to format the information present in the structured description for presentation.

The document obtained is directly usable, for instance, by a developer for debugging purposes. In this document, readability of the bit stream is achieved by indicating the field semantics in association with the value of the field.

In an advantageous embodiment of the invention, when the bit stream format is such that the value of at least one field has semantics (called value semantics), the enhanced schema further includes a component containing a list of {value; value semantics} pairs for that field. During the syntactical analysis of the bit stream, comparing the value of the field in the bit stream with the list of values defined in the schema allows retrieving the associated value semantics. The retrieved value semantics are added to the structured description. Eventually, the document produced after transformation of the structured description comprises said value semantics.

Giving the value semantics in addition to (or instead of) the value itself increases the readability of the document for the user.

The method of issuing a bit stream according to the invention is advantageous because it is applicable to any bit stream format as far as the bit stream format is generically described in an available schema.

Another advantage of the proposed solution is that:
the structured description generated with the method of the present invention can still be used for achieving other transformations than the formatting transformation described above; for instance it may be used for producing an adapted description of a bit stream as described in International Patent Application WO02/063494 filed by Koninklijke Philips Electronics N.V. and published on Aug. 15, 2002;
the enhanced schema proposed in the present invention can still be used to produce a bit stream from a bit stream description as described in International Patent Application WO02/069187.

### BRIEF DESCRIPTION OF THE DRAWINGS

These and other aspects of the invention will be further described with reference to the following drawings:

FIG. 1 is a block diagram of a method according to the invention of issuing a bit stream;

FIG. 2 is a schematic diagram of a working station intended to be operated by a developer for issuing a document generated with a method according to the invention.

### DESCRIPTION OF PREFERRED EMBODIMENT

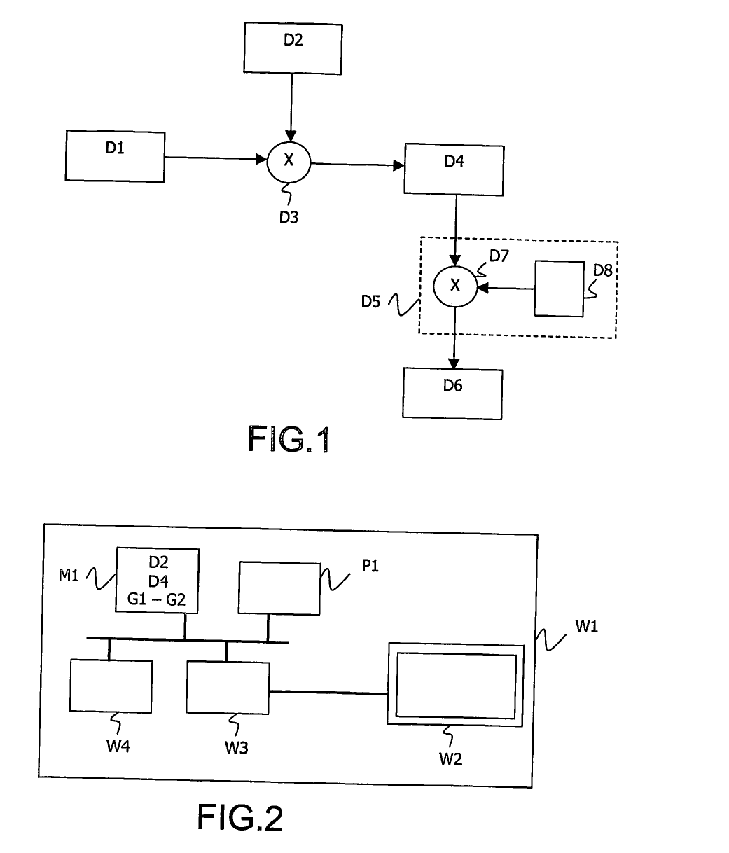

FIG. 1 shows a block diagram explaining the basic mode of operation of a method of issuing a bit stream according to the invention. A block D1 represents an input bit stream containing data organized in fields according to a certain bit stream format. Each field of the bit stream has a value and semantics. A block D2 represents a schema according to the invention. The schema D2 generically describes said bit stream format. A block D3 represents a syntactical analyzer that generates an instance D4 of the schema D2 from the input bit stream D1. The instance generated by the syntactical analyzer D3 is a structured description of the bit stream D1. It comprises the value of the fields (recovered from the bit stream) and the field semantics for at least part of the fields defined in the bit stream format. A block D5 represents a transformation that is applied to the structured description D4 so as to format the content of the structured description D4 and produce a document D6 that is readable for the user.

The schema D2 describes the syntax of the bit stream, notably the type of data that may be contained in the bit stream and the manner in which these data are to be included in the structured document D4. It is not always necessary to give complete details of the structure of the bit stream format in the schema. The level of detail depends on the application considered. Consequently some of the fields defined in the bit stream format may not be detailed in the schema D2.

Advantageously, the schema D2 is of the type disclosed in the above-mentioned patent application which means that:
a) it defines one oo more types of data which may contain one or more facets, notably:
when said format uses binary words of a predefined length, one ore more types of data corresponding to said binary words of a predefined length, said types of data having at least one facet relating to said length and, when said binary words of a predefined length may contain one or more padding bits, said types of data having a facet relating to said padding bits,
when said format uses binary segments of an indefinite length which have content intended to be imported in said structured description by using a certain import mode, a type of data corresponding to said binary segments, said type of data having at least one facet relating to said import mode and, when said binary segments are defined by a stop flag, said type of data having one facet relating to said stop flag,
b) it comprises elements for which it describes a name, a type of data, an imbrication, an order, a predefined or undefined number of occurrences, the occurrence of an element being mandatory or optional,
c) when the format provides that data situated ahead in the bit stream give information about the structure or the content of a subsequent part of the bit stream,
it defines one or more variables constituted by an access path in the structured representation to said data situated ahead in the bit stream,
and it comprises one or more conditional branches for describing various possible structures or contents as a function of the value of said variables.

In a preferred embodiment, the schema D2 is written in a language that is derived from XML-schema. This derived language and the above-mentioned components of the schema D2 are fully described in International Patent Application WO02/069187.

Some of the elements mentioned at point b) above are associated with a field of the bit stream (the other elements describe the structure of the document D4).

According to the present invention, the schema D2 further comprises, for the elements mentioned at point b) above that are associated with a field of the bit stream, a component containing the field semantics for that particular field. For instance, the field semantics are added to the schema D2 by using the component “xsd:documentation” defined in XML-schema.

Advantageously, when the schema describes a field for which each possible value has specific associated semantics (called value semantics), the schema D2 also comprises a component containing a list of {value; semantics} pairs for that field. For instance, said list is added to the schema by using the component “xsd:appinfo” (“xsd:appinfo” is defined in XML-schema for holding application-specific information). The content of the “xsd:appinfo” component of a schema is not taken into account in the XML-schema validation process. This means that the information added in the “xsd:appinfo” components are ignored by XML-schema.

According to XML-schema, the components “xsd:documentation” and “xsd:appinfo” must also be enclosed in a component “xsd:annotation”.

It is also useful to define a specific hierarchy to be used by the transformation D5 for presenting the bit stream. This allows presenting the fields of a first hierarchical level in a first style, and the fields of a second hierarchical level in a second style (the hierarchical level referred to here is a presentation level; it does not necessarily correspond to the hierarchy of the field in the bit stream). XML-schema gives the possibility to define new attributes for specific schema components by qualifying them with a specific namespace. In an advantageous embodiment of the invention, a presentation level is added to the schema by using such an attribute. In the following description the attribute used to add this presentation level to the schema is named “bv:presLevel” (in the following description, the prefix “xsd” is used to refer to the XML-schema conventional namespace and the prefix “bv” is used to refer to extensions introduced by the present invention; in the Annex, the prefix “bsdl” refers to the extensions of the L-schema that were defined in International Patent Application WO02/069187).

Annex A gives an extract of a schema according to the invention that generically describes the JPEG 2000 bit stream format (JPEG 2000 is described in the document ISO/IEC FCD 15444-1 “JPEG 2000 Final Draft International Standard”). The components that are added to the schema according to the invention are written in bold letters.

For instance, it can be seen from Annex A that the field “SIZ” has to be presented by applying a presentation level “1”. It can also be seen that the field semantics of the field “Rsiz” are “Decoder capabilities”, and that the field “Rsiz” may have different values. The value semantics of the value “0” are “Capabilities specified in this Recommendation|International Standard only” (ie. when the field “Rsiz” takes value “0”, this means that the decoder capabilities are specified in the recommendation/International Standard only). The value semantics of any other value (referred to by “default” in the schema) are “reserved”.

The syntactical analyzer D3 uses the schema D2 to parse the bit stream D1 and generate a structured description D4 of the bit stream D1. The structured description D4 comprises a plurality of elements each associated with a field of the bit stream. The value of each element is calculated from the associated binary representation in the bit stream D1 and the associated data type in the schema D2 (which means that the value contained in the structured description is formatted according to the data type definition given in the schema). This process is fully described in International Patent Application WO02/069187.

According to the present invention, the syntactical analyzer D3 further adds one or more attributes to the elements of the structured description D4.

In the simplest embodiment of the invention, the syntactical analyzer D3 adds an attribute containing the field semantics contained in the “xsd:documentation” component described above. In the following description, this attribute is named “bv:fieldSemantics”.

In more sophisticated embodiments of the invention, the syntactical analyzer D3 also adds one or more of the following attributes:
if a list of {value; value semantics} pair is given in the schema D2, the syntactical analyzer D3 compares the value directly recovered from the bit stream D1 with the list of pre-defined values, and it adds the corresponding value semantics to the instance element via an attribute named “bv:valueSemantics”;
if the schema D2 comprises presentation level information, the syntactical analyzer D3 copies said information into the instance element;
as explained above, the field value that is directly recovered from the bit stream D1 is formatted according to the data type definition given in the schema D2; when the field value is neither in the hexadecimal nor in the binary format, the syntactical analyzer D3 advantageously reformats the field value either into the hexadecimal or into the binary format and adds the reformatted value to the instance element with an attribute named “bv:value”;
the syntactical analyzer D3 advantageously adds to the instance element an attribute named “bv:offset” indicating the location of the field in the bit stream D1.

Annex B gives an extract of an example of a structured description obtained according to the invention from a JPEG 2000 input bit stream. In Annex B the added attributes are presented in bold letters.

According to the invention, a transformation D5 is applied to the structured description D4 generated by the syntactical analyzer D3. The object of the transformation D5 is to produce a document D6 in an easily readable format (the transformation D6 does not modify the information contained in the structured description. It only formats said information for presentation purposes. In particular when the structured description D4 contains presentation level information, the transformation uses this information when generating the document D6.

Advantageously, the transformation D5 is defined in an XSLT style sheet. XSLT is a tool of XML that allows defining transformations to be applied to XML documents. In an XSLT transformation, an XSLT processor reads an XML document and an XSLT style sheet so as to generate a transformed document. In FIG. 1, the XSLT processor is denoted by reference D7 and the XSLT style sheet is denoted by reference D8.

Advantageously in the invention the transformed document D6 is written in the HTML or XHTML language.

Annex C gives an example of a style sheet to be applied to the structured description of Annex B. Annex D gives an example of an XHTML document that is generated by applying the style sheet of Annex C to the structured description of Annex B.

It can be seen from Annex D that the field “Main header” (having a presentation level “2” in the structured description of Annex B) is presented with a first presentation style, the fields “SOC” and “SIZ” (both having a presentation level “1” in Annex B) are presented with a second presentation style, and the other fields (no presentation level defined in Annex B) are presented with a third presentation style.

It can also be seen that the value semantics for the field “Rsiz” takes the place of the value recovered from the bit stream.

FIG. 2 is a block diagram of a working station W1 intended to be operated by a developer for issuing a document generated with a method according to the invention. According to FIG. 2 a working station W1 comprises a display W2 controlled by a display controller W3 and a man-machine interface W4 allowing inputs by the developer. The working station W1 also comprises a processor P1 and at least one memory M1. The memory M1 stores at least a schema D2 that generically describes a bit stream format, a program G1 for implementing the syntactical analyzer D3 when executed by the processor P1, and a program G2 for implementing a transformation D5 when executed by the processor P1. Execution of the program G1 comprises reading an input bit stream D1 and a schema D2 and leads to the generation of a structured description D4. The structured description D4 is advantageously stored in the memory M1. Execution of the program G2 comprises reading the structured description D4 and the style sheet D7. It leads to the generation of a document D6. The document D6 is advantageously passed to the display controller W3 for display.

A plurality of memories can be used for storing the above-mentioned data (bit stream D1, schema D2) and programs (program G1 implementing the syntactical analyzer D3 and program G2 implementing the transformation D5).

One or more schema can be stored on a removable storage medium (for instance on an optical disc) together with the programs G1 and G2 so as to allow implementation of the method of the invention on any work station comprising a reader for reading such an optical disc.

With respect to the described method, schema, programs and storage medium, modifications or improvements may be proposed without departing from the scope of the invention. The invention is thus not limited to the examples provided.

In particular, the invention is not restricted to the languages used in the above description (XML, XML-schema, HTML, XHTML, XSLT). The invention can be implemented by using other languages, for instance languages of the DSD type (Document Structure Description, proposed by AT&T and BRICS from the university of Aarhus in Denmark, available on the Internet at http://www.brics.dk/DSD).

The invention is neither restricted to any particular bit stream format. It is applicable to any format as far as this format can be described in a schema of the type disclosed in the present patent application.

The invention has been described by reference to International Patent Application WO02/069187. However, the invention is not limited to the type of schema described in this prior-art document. It applies to any schema that generically describes the format of a bit stream.

Use of the verb “comprise” and its conjugations does not exclude the presence of elements or steps other than those stated in the claims. Use of the article “a” or “an” preceding an element or step does not exclude the presence of a plurality of such an element or step.

ANNEX D: Example of document obtained by applying the style
sheet of Annex C to the structured representation of Annex B
Main header

Start of codestream (SOC)

| | | | |
|---|---|---|---|
| Marker | FF4F | 0xFF4F | 0x00 |

Image and tile size (SIZ)

| | | | | |
|---|---|---|---|---|
| Marker | Marker | FF51 | 0xFF51 | 0x02 |
| Marker segment length | LMarker | 47 | 0b101111 | 0x04 |
| Decoder capabilities | Rsiz | Capabilities specified in this | 0b0 | 0x06 |
| | | Recommendation \| | | |
| | | International Standard only | | |
| Width of the reference | Xsiz | 640 | 0b1010000000 | 0x08 |
| grid | | | | |
| Height of the reference | Ysiz | 480 | 0b111100000 | 0x0c |
| grid. | | | | |
| Horizontal offset from | XOsiz | 0 | 0b0 | 0x10 |
| the origin of the | | | | |
| reference grid to the left | | | | |
| side of the image area | | | | |
| Vertical offset from the | YOsiz | 0 | 0b0 | 0x14 |
| origin of the reference | | | | |
| grid to the top side of the | | | | |
| image area | | | | |
| Width of one reference | XTsiz | 640 | 0b1010000000 | 0x18 |
| tile wrt reference grid | | | | |
| Height of one reference | YTsiz | 480 | 0b111100000 | 0x1c |
| tile wrt reference grid | | | | |
| Horizontal offset from | XTOsiz | 0 | 0b0 | 0x20 |
| the origin of the | | | | |
| reference grid to the left | | | | |
| side of the first tile | | | | |
| Vertical offset from the | YTOsiz | 0 | 0b0 | 0x24 |
| origin of the reference | | | | |
| grid to the top side of the | | | | |
| first tile | | | | |
| Number of components | Csiz | 3 | 0b11 | 0x28 |

1. A method of issuing a bit stream organized in fields according to a certain format, said fields having a value and semantics called field semantics, said method comprising the steps of:
A) syntactically analyzing said bit stream by reading a schema that generically describes said format and includes, for at least part of said fields, a component containing said field semantics, for generating an instance of said schema that is a structured description of said bit stream and comprises the field semantics and the value of at least part of said fields,
B) applying a transformation to the structured description obtained in step A) so as to produce a document comprising at least the field semantics and an indication of the value of at least part of the fields of said bit stream.

2. A method as claimed in claim 1, wherein the indication of the value of a field comprises at least one of the following:
the value recovered from the bit stream,
a reformatted value obtained by reformatting the value recovered from the bit stream.

3. A method as claimed in claim 1 of issuing a bit stream having at least a field whose value has semantics called value semantics, wherein:
said schema further includes a component containing a list of {value; value semantics} pairs for that field,
step A) includes comparing the value recovered from the bit stream for that field to said list so as to retrieve the value semantics of said value, and adding said value semantics to the structured description that is generated, and
step B) is designed to produce a document that comprises said value semantics.

4. A method as claimed in claim 3, wherein the indication of the value of a field comprises at least one of the following:
the value recovered from the bit stream,
a reformatted value obtained by reformatting the value recovered from the bit stream,
the value semantics if any.

5. A method of issuing a bit stream as claimed in claim 1, wherein the fields have a localization in the bit stream, and step B) includes adding an indication of the localization of the fields in said document.

6. A method of issuing a bit stream as claimed in claim 1, wherein step A) further comprises adding a presentation indication to the structured description for at least part of said fields, and step B) further includes processing said presentation indication so as to apply a specific presentation style depending on said presentation indication.

7. A schema that generically describes a bit stream format according to which a bit stream is being organized in fields, said fields having a value and semantics called field semantics, said schema including, for at least part of said fields, a component containing said field semantics.

8. A schema as claimed in claim 7, describing a bit stream format according to which the value of at least one field has semantics, called value semantics, said schema further including a component containing a list of {value; value semantics} pairs for that field.

9. A computer program comprising instructions for implementing a method of issuing a bit stream as claimed in claim 1, when said program is executed by a processor.

10. Software comprising one or more schema as claimed in claim 7 and one or more program comprising instructions for implementing a method of issuing a bit stream when said program is executed by a processor.

11. Storage medium for storing software as claimed in claim 10.
